(19) United States
(12) Patent Application Publication
(10) Pub. No.: US 2015/0087341 A1
(43) Pub. Date: Mar. 26, 2015

(54) HOME NODE B (HNB) LOCATION SERVICES

(71) Applicant: QUALCOMM Incorporated, San Diego, CA (US)

(72) Inventors: Stephen William EDGE, Escondido, CA (US); Luis F.B. LOPES, Swindon (GB)

(73) Assignee: QUALCOMM Incorporated, San Diego, CA (US)

(21) Appl. No.: 14/280,349

(22) Filed: May 16, 2014

Related U.S. Application Data
(60) Provisional application No. 61/880,625, filed on Sep. 20, 2013.
(60) Provisional application No. 61/881,341, filed on Sep. 23, 2013.
(60) Provisional application No. 61/881,925, filed on Sep. 24, 2013.
(60) Provisional application No. 61/931,926, filed on Jan. 27, 2014.

(51) Int. Cl. H04W 4/04

(52) U.S. Cl. CPC H04W 4/04
USPC 455/456.5

(57) ABSTRACT

System and method for determining location on a Home Node B (HNB). In one embodiment, a method of supporting determining a location of an HNB includes sending a Positioning Calculation Application Part (PCAP) position initiation request towards a Standalone Serving Mobile Location Center (SAS) for positioning including a HNB identification value, receiving a PCAP position activation request for A-GNSS, obtaining GNSS measurements at the HNB, sending a PCAP position activation response for A-GNSS, receiving a PCAP position initiation response, and storing a location of the HNB based on the PCAP position initiation response.

### CROSS-REFERENCE TO RELATED APPLICATIONS

This application claims the benefit of U.S. Provisional Application No. 61/880,625, titled “Home Node B (HNB) Location Services,” filed on Sep. 20, 2013, and U.S. Provisional Application No. 61/881,341, “Home Node B (HNB) Location Services,” filed on Sep. 23, 2013, and U.S. Provisional Application No. 61/881,925, “Home Node B (HNB) Location Services,” filed on Sep. 24, 2013, and U.S. Provisional Application No. 61/931,926, “Home Node B (HNB) Location Services,” filed on Jan. 27, 2014, each of which are assigned to the assignee hereof and the contents of which are incorporated herein by reference in their entirety.

### BACKGROUND

I. Field

The present disclosure relates generally to communication, and more specifically to techniques for providing location services to a Home Node B (HNB) in a wireless network.

II. Background

HNBs are home base stations (sometimes referred to as femtocells or femto base stations) that are becoming increasingly popular and more widely deployed at various locations such as homes, offices, shops, apartments, and large indoor venues such as museums, train stations, airports, etc. These HNBs typically serve as base stations for a wireless network operator (normally using licensed radio frequencies) and may be used to improve radio coverage, increase throughput, and/or provide other benefits for the network operator and/or users. Unlike macro base stations that are carefully deployed at specific locations and maintained by network operators, HNBs may be flexibly deployed in an unplanned manner at any location by users and/or by operators.

An HNB may support communication for one or more user equipments (UEs) within its coverage. In one type of deployment, an HNB may support communication from only a small set of uses (e.g. in the case of deployment in a house or office). In another deployment, known as a small cell deployment, an HNB may support communication from a large population of users (e.g. in the case of deployment in a shopping mall, museum, hospital or airport). It may be desirable or necessary to know the location of the HNB. For example, it may be necessary to know the location of the HNB in order to ensure that it is authorized to operate at its current location (e.g., is within a geographic area for which the associated network operator has a license to use the radio frequencies supported by the HNB). It may also be useful to know the location of an HNB in order to help accurately position a UE that is accessing or nearby to the HNB—e.g. if the user of the UE makes an emergency call and the location of the UE needs to be transferred to a Public Safety Answering Point (PSAP).

A HNB may have the capability to autonomously determine its location without any assistance from a network. For example, the HNB may support positioning using standalone Global Navigation Satellite System (GNSS) and may be able to determine its location based on signals received from satellites in a GNSS. A GNSS may comprise the United States Global Positioning System (GPS), the European Galileo System, the Russian GLONASS system, the Chinese Beidou system or some other system. A location estimate obtained with standalone GNSS may have good accuracy. However, since an HNB may typically be deployed indoors where signals from GNSS satellites will typically be attenuated and subject to multipath, standalone GNSS may have some disadvantages such as a relatively long time to first fix (TTFF), reduced accuracy and reduced location yield. Hence, techniques that can improve performance over standalone GNSS for HNBs may be highly desirable.

### SUMMARY

Techniques for supporting location services for HNBs are described herein. A location service may include Assisted GNSS (A-GNSS), which may have certain advantages over standalone GNSS.

An example method of supporting positioning of a Home Node B (HNB) according to the disclosure includes sending a Positioning Calculation Application Part (PCAP) information exchange initiation request for assistance data, receiving a PCAP information exchange initiation response and the assistance data, utilizing the assistance data to obtain satellite signal information, and determining a location of the HNB based on the satellite signal information.

Implementations of such a method may include one or more of the following features. The PCAP information exchange initiation request may include an HNB identification value. The HNB identification value may uniquely identify the HNB. The HNB identification value may indicate that the HNB is an HNB. The PCAP information exchange initiation request may include an approximate location of the HNB. The HNB identification value may include a reserved International Mobile Subscriber Identity (IMSI) value or a reserved International Mobile Equipment Identity (IMEI) value.

An example of a method of supporting positioning of a Home Node B (HNB) according to the disclosure includes obtaining GNSS measurement information with the HNB, sending a Positioning Calculation Application Part (PCAP) position calculation request including the GNSS measurement information, receiving a PCAP position calculation response, and storing a location of the HNB based on the PCAP position calculation response.

Implementations of such a method may include one or more of the following features. The PCAP position calculation request may include an HNB identification value. The HNB identification value may include a reserved IMSI or IMEI value. The HNB identification value may indicate positioning of an HNB.

An example of a method of determining location on a Home Node B (HNB) according to the disclosure includes sending a Positioning Calculation Application Part (PCAP) position initiation request towards a Standalone Serving Mobile Location Center (SAS) for positioning including a HNB identification value, receiving a PCAP position activation request for A-GNSS, obtaining GNSS measurements at the HNB, sending a PCAP position activation response for A-GNSS, receiving a PCAP position initiation response, and storing a location of the HNB based on the PCAP position initiation response.

Implementations of such a method may include one or more of the following features. A request for additional assistance data may be sent towards the SAS, and additional assistance data based on the request may be received. The PCAP position activation request for A-GNSS and the PCAP position initiation response may be received from a HNB Gateway (GW). The HNB identification value may be a value for a Client Type parameter. The HNB identification value may include a common reserved IMSI or IMEI value. The HNB identification value may indicate the location of the HNB to the SAS. In response to the indication of the location of the HNB, the SAS may not request measurements not supported by the HNB. A PCAP position activation request for Enhanced Cell ID (E-CID) measurements from the SAS may be received, and an approximate location for the HNB may be returned to the SAS in a PCAP position activation response.

An example of an apparatus for determining location on a Home Node B (HNB) according to the disclosure includes a storage medium storing instructions, and a processor communicatively coupled to the storage medium and configured to: send a Positioning Calculation Application Part (PCAP) position initiation request towards a Standalone Serving Mobile Location Center (SAS) for positioning including a HNB identification value, receive a PCAP position activation request for A-GNSS, obtain GNSS measurements at the HNB, send a PCAP position activation response for A-GNSS, receive a PCAP position initiation response, and store a location of the HNB based on the PCAP position initiation response.

Implementations of such an apparatus may include one or more of the following features. The processor may be further configured to send a request for additional assistance data towards the SAS, and receive additional assistance data based on the request. The PCAP position activation request for A-GNSS and the PCAP position initiation response may be received from a HNB Gateway (GW). The HNB identification value may include a value for a Client Type parameter. The HNB identification value may indicate positioning of an HNB to the SAS. The HNB identification value may include a common reserved IMSI or IMEI value. In response to the indication of HNB positioning, the SAS may not request measurements not supported by the HNB. In response to the indication of HNB positioning, the SAS may store the location of the HNB. Receiving the PCAP position activation request may include a request for E-CID measurements from the SAS, and the PCAP position activation response may include returning an approximate location for the HNB to the SAS.

An example of a non-transitory processor-readable storage medium comprising instructions determining location on a Home Node B (HNB) according the disclosure includes code for sending a Positioning Calculation Application Part (PCAP) position initiation request towards a Standalone Serving Mobile Location Center (SAS) for positioning including a HNB identification value, receiving a PCAP position activation request for A-GNSS, obtaining GNSS measurements with the HNB, sending a PCAP position activation response for A-GNSS, receiving a PCAP position initiation response, and storing a location of the HNB based on the PCAP position initiation response.

Items and/or techniques described herein may provide one or more of the following capabilities and/or possibly one or more other capabilities not mentioned. An HNB may initiate a request for a location service. The HNB may communicate with a location server via a control plane location solution. A location server may be used to support location services and A-GNSS for HNBs. The location server may be coupled to an HNB Gateway (HNB GW), which may be seen as a Radio Network Controller (RNC) by the location server. The HNB may exchange Positioning Calculation Application Part (PCAP) messages with the location server via the HNB GW to support the location service for the HNB. The PCAP messages may include a value in a Client Type parameter in a PCAP Initiation Request to indicate HNB positioning. The HNB may be configured to exchange Radio Resource Control (RRC) messages with a UE to support the location service for the UE. Further, it may be possible for an effect noted above to be achieved by means other than they noted and a noted item/technique may not necessarily yield the noted effect.

### BRIEF DESCRIPTION OF THE DRAWINGS

FIG. 1 shows an exemplary wireless network.

FIG. 2A shows a message flow of an information exchange initiation between an HNB and a SAS.

FIG. 2B shows a message flow of a position calculation procedure to query an SAS for a position estimate of an HNB.

FIG. 3 shows a message flow for supporting A-GNSS for an HNB.

FIG. 4 shows block diagrams of an HNB and a SAS.

FIG. 5 is an exemplary process flow of supporting location services for an HNB.

FIG. 6 is an exemplary process flow for storing a location of an HNB.

FIG. 7 is an exemplary process for determining a HNB identification from a PCAP information exchange initiation request.

### DETAILED DESCRIPTION

The techniques described herein for supporting location services for HNBs may be used for various wireless networks and radio technologies, including those defined by organizations named “3rd Generation Partnership Project” (3GPP) and “3rd Generation Partnership Project 2” (3GPP2). For example, the techniques may be used for a Wideband Code Division Multiple Access (WCDMA) network implementing Universal Terrestrial Radio Access (UTRA) defined by 3GPP, a Long Term Evolution (LTE) network implementing Evolved Universal Terrestrial Radio Access (E-UTRA) defined by 3GPP, etc. WCDMA is part of Universal Mobile Telecommunication System (UMTS). LTE is part of 3GPP Evolved Packet System (EPS). WCDMA, LTE, UTRA, E-UTRA, UMTS and EPS are described in documents from 3GPP. The techniques may also be used for other wireless networks (e.g., 3GPP and 3GPP2 networks) and other radio technologies. The techniques described herein are an extension of the techniques described in U.S. patent application Ser. No. 13/085,395, filed Apr. 12, 2011 and titled “Method and Apparatus For Supporting Location Services Via a Home Node B (HNB),” which is incorporated herein by reference in its entirety.

The techniques described herein may also be used in association with various positioning protocols such as (i) LTE Positioning Protocol (LPP), Radio Resource LCS Protocol (RRLP), and Radio Resource Control (RRC) defined publicly by 3GPP, (ii) C.S0022 (also known as IS-801) defined publicly by 3GPP2, and (iii) LPP Extensions (LPPe) defined publicly by the Open Mobile Alliance (OMA). A positioning protocol may be used to coordinate and control positioning of devices. A positioning protocol may define (i) procedures that may be executed by a location server and a device being positioned and (ii) communication or signaling between the device and the location server.

The techniques described herein may be used to support positioning of a UE and/or an HNB using positioning methods such as Assisted GNSS (A-GNSS) and Enhanced Cell ID (E-CID). A-GNSS and E-CID may each be supported, in part or in whole, by positioning protocols such as LPP, RRC. RRLP, IS-801 and LPPe and in such a case may be used in the manner defined by the 3GPP, 3GPP2 and OMA definitions of these positioning protocols.

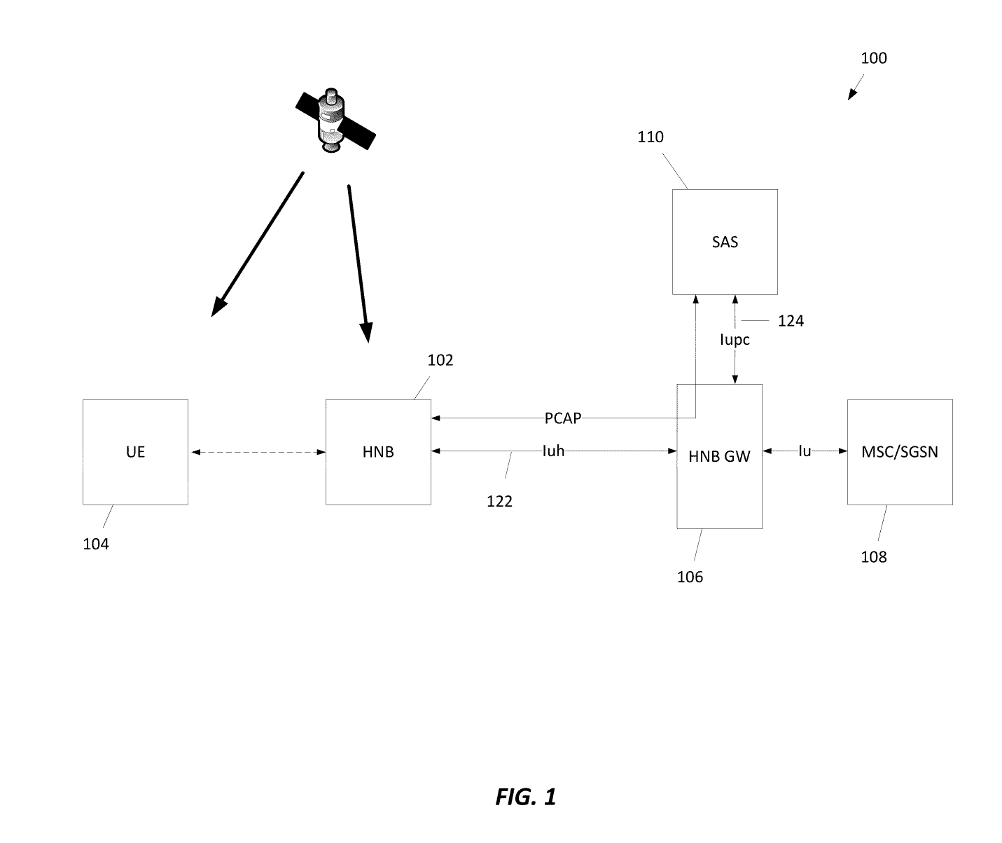

FIG. 1 shows a wireless network 100 that supports communication and location services. HNB 102 may be deployed to support radio communication for one or more UEs 104 within the coverage of the HNB 102. UE 104 may be a cell phone, smart phone, tablet, laptop or other mobile device able to communicate wirelessly with base stations such as HNB 102 in a wireless network such as wireless network 100. Additional HNB stations (not shown) may be deployed at different locations (e.g., in different stories of a multi-story building) and configured to communicate with multiple UEs (not shown). The HNB 102 may also be referred to as a home base station, a femto access point (FAP), a Home evolved Node B (HeNB), a small cell base station, a femtocell etc. HNB 102 may support radio access using WCDMA or some other radio technology. An HNB Gateway (GW) 106 may be coupled to the HNB 102 and other HNBs and may support inter-working between the HNBs and other network entities. Other network entities may include entities supporting various functions and services for wireless network 100. For example, the wireless network 100 may include a Mobile Switching Center (MSC), a Serving GPRS Support Node (SGSN) (i.e., depicted as an MSC/SGSN element 108), and/or other network entities. An MSC may perform switching functions for circuit-switched (CS) calls and may also route Short Message Service (SMS) messages. A SGSN may perform signaling, switching and routing functions for packet-switched (PS) connections and sessions for UEs. The MSC/SGSN element 108 may represent either an MSC or an SGSN (e.g. not both combined) and may communicate with certain other network elements (e.g. an HNB GW) using an Iu interface. MSC/SGSN 108 may also communicate with other entities not shown in FIG. 1 such as a Public Switched Telephone Network (PSTN), the Internet or a Gateway GPRS Support Node. A Standalone Serving Mobile Location Center (SAS) 110 or some other location server may be used to support location services including E-CID and/or A-GNSS for HNBs and UEs. A SAS may typically be used in a 3GPP network, may be connected to an HNB GW 106 or to a number of HNB GWs, which may each be seen as a Radio Network Controller (RNC) by the SAS. SAS 110 may also connected to one or more RNCs (not shown in FIG. 1) and may be used to support location of UEs accessing the wireless network 100 including but not limited to UE 104. The wireless network 100 may be connected to other networks, e.g., other wireless networks, the Internet and/or the PSTN.

In operation, the HNB GW 106 may be connected to HNB 102 (e.g. via a direct link or via the Internet) and may support inter-working between the HNB and other network entities such as MSC/SGSN 108. The HNB 102 and the HNB GW 106 may utilize a Radio Access Network Application Part (RANAP) User Adaption (RUA) protocol to transfer messages for other protocols, such as the Radio Access Network Application Part (RANAP) protocol, between HNB 102 and HNB GW 106 over an Iuh interface 122 as defined in 3GPP Technical Specification (TS) 25.468. The SAS 110 may support location services and positioning for UEs (e.g. UE 104) accessing the wireless network 100 and/or for HNBs (e.g. HNB 102) within wireless network 100. The SAS 110 may communicate with the HNB GW 106 via an Iupc interface 124 which may enable transfer of messages supporting positioning related protocols, such as the Positioning Calculation Application Part (PCAP) protocol defined in 3GPP TS 25.453, between the SAS 110 and HNB GW 106. For simplicity, FIG. 1 shows only some network entities that may be present in wireless network 100. Wireless network 100 may include other network entities. An HNB 102 may be one of many HNBs supported by wireless network 100.

HNB 102 may support standalone GNSS and may be able to determine its location based on its standalone GNSS capability. Standalone GNSS may be able to provide an accurate location estimate in some environments (e.g. if HNB 102 is located outdoors) but may have some disadvantages. For example, standalone GNSS may require the signal strength of the best satellite at a received (e.g. HNB 102) to be about −145 dBm or better in order for the receiver to demodulate GNSS navigation data which may be needed to calculate a position at the receiver using measurements of satellite signals. Furthermore, the time to first fix (TTFF) for standalone GNSS may be on the order of minutes or longer at low signal strength in order to allow the receiver to acquire and measure enough signals to obtain a location estimate.

Assisted GNSS (A-GNSS) may provide better performance than standalone GNSS and/or may ameliorate some of the disadvantages of standalone GNSS. For A-GNSS, a device (e.g. a UE 104 or HNB 102) may obtain assistance data for satellites from a network (e.g. from an SAS such as SAS 110) and may use the assistance data to search and acquire satellites. The assistance data may enable the device to more quickly detect satellites, to detect satellites at a lower received signal level, and to avoid having to demodulate satellite navigation data, etc. For example, A-GNSS may work even when the signal strength of the best satellite is about −155 dBm or less, which may be at least 10 dB better than for standalone GNSS. TTFF may be on the order of tens of seconds for A-GNSS instead of minutes or longer for standalone GNSS. The increased sensitivity and lower minimum signal strength for A-GNSS may be especially desirable for HNBs, which are likely to be deployed indoors. The shorter TTFF may provide better user experience—e.g. may allow an HNB 102 to determine its location accurately when initializing, thereby reducing the time needed for an HNB 102 to determine that it is at a location where operation in licensed operator spectrum is permitted.

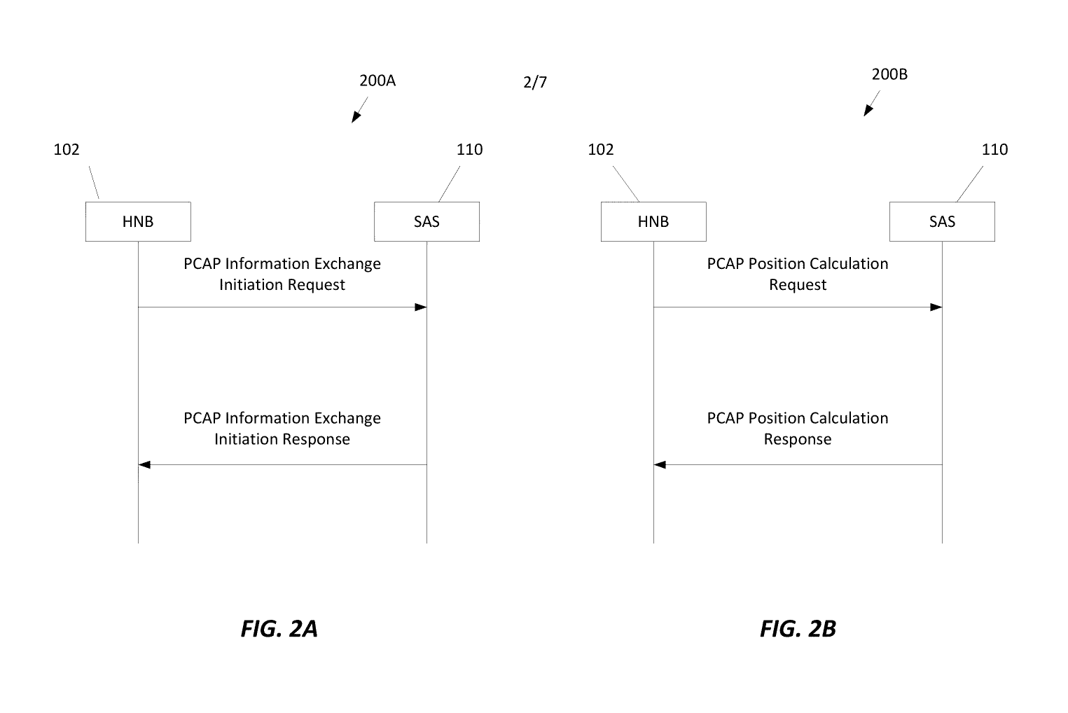

FIG. 2A shows a message flow 200A of an information exchange initiation between an HNB 102 and a SAS 110. The PCAP Information Exchange procedure (i.e., as defined in 3GPP TS 25.453) may be used to enable an HNB 102 to request specific A-GNSS assistance data from the SAS 110 for subsequent HNB based positioning. A PCAP information exchange initiation request message may be sent by the HNB 102 in order to request assistance data for A-GNSS from SAS 110. In an example, the PCAP information exchange request message may include an HNB identification value. The HNB identification value may identify the sender of the message as being an HNB and may in addition uniquely identify the particular HNB (e.g., using a serial number, device identity, IP address, MAC address, SSID, serving cell identity, IMSI or IMEI), or may just identify the sender of the PCAP information exchange initiation request message as an HNB without uniquely identifying the HNB, or may not provide any HNB indication. In an embodiment, the approximate initial position allowed by the PCAP protocol in the PCAP information exchange initiation request message (e.g. to enable the SAS 110 to compute GNSS acquisition assistance data for the HNB) could be the approximate HNB 102 position calculated from other methods (e.g., standalone GNSS, use of a nearby cell ID observed by HNB 102 or an implied location based on an IP address assigned to HNB 102 by an Internet Service Provider). The message flow 200A varies from previous standards in that the HNB 102 is being utilized instead of an RNC and the procedure is invoked by HNB 102 in order to position HNB 102 and not a UE (e.g. such as UE 104). The message flow 200A may flow through a HNB GW 106 (not shown in FIG. 2A) that may act as a relay and transfer PCAP messages between HNB 102 and SAS 110. SAS 110 may use any HNB identification value that is included in the PCAP Information Exchange Initiation Request message (whether this uniquely identifies HNB 102 or just identifies HNB 102 as being an HNB) to provide certain types of assistance data to HNB 102—e.g., types of assistance data (e.g. for A-GNSS) configured in SAS 110 that are more suitable or useful to an HNB. SAS 110 may return the assistance data in a PCAP Information Exchange Initiation Response message (e.g. via HNB GW 106). The assistance data received by HNB 102 from the SAS 110 may be used by the HNB 102 to help the HNB 102 acquire satellites and make measurements of satellite signals. The assistance data received from SAS 110 may be further used by the HNB 102 to help compute the location of the HNB 102 once the HNB 102 has made measurements of the GNSS satellites.

FIG. 2B shows a message flow 200B of a position calculation procedure to query an SAS 110 for a position estimate of an HNB 102. The PCAP Position Calculation procedure (i.e., as defined in 3GPP TS 25.453) may be used to enable an HNB 102 to send GNSS measurements to the SAS 110 for position calculation and for SAS 110 to subsequently return a computed position estimate of HNB 102 to HNB 102. The message flow 200B may be invoked after HNB 102 has obtained GNSS measurements. The message flow 200B varies from previous approaches in that it is not dependent on an RNC and is used to compute the position of HNB 102 rather than some UE (e.g. UE 104). The HNB 102 starts the message flow 200B by sending a PCAP Position Calculation Request message to SAS 110 (e.g. via an HNB GW 106 not shown in FIG. 2B) and may include in the PCAP Position Calculation Request message measurements of GNSS satellites obtained by HNB 102 (e.g. GNSS code phase measurements). The SAS 110 may be configured to compute a location of the HNB 102 based on the GNSS measurements obtained and sent by the HNB 102. The SAS 110 may return the computed location to HNB 102 in a PCAP Position Calculation Response message (e.g. transferred via HNB GW 106 not shown in FIG. 2B).

In some implementations, the message flow 200B may be initiated by HNB 102 after the message flow 200A has been used by HNB 102 to obtain GNSS assistance data from SAS 110 and after HNB 102 has acquired and measured GNSS satellite signals with the help of this assistance data. In this case, the message flow 200B may be instigated by HNB 102 as an alternative to computing the position of HNB 102 by HNB 102. In other implementations, message flow 200A may not be used or may be invoked by HNB 102 at some earlier time and message flow 200B may be used in isolation by HNB 102 to obtain its location from SAS 110 after HNB 102 has made some GNSS measurements. In an example, the PCAP position calculation request message sent by the HNB 102 to the SAS 110 in message flow 200B may include an HNB identification value. The HNB identification value may identify the sender of the message as being an HNB and may in addition uniquely identify the particular HNB as being the HNB 102 (e.g., using a serial number, device identity, IP address, MAC address, SSID, serving cell identity, IMSI or IMEI). In some implementations, certain IMSI or IMEI values may be reserved to identify an HNB and may be included in the PSAP position calculation request message.

In some embodiments, an HNB 102 may be configured (e.g. at manufacture or during initialization) with a unique IMSI and/or a unique IMEI value that both identifies HNB 102 as being an HNB and uniquely identifies HNB 102 (e.g. distinguishes the HNB 102 from any other HNB belonging to wireless network 100). In other embodiments, a common reserved IMSI or IMEI value may be configured in HNB 102 (e.g. at manufacture or during initialization) that identifies HNB 102 as being an HNB but does not distinguish HNB 102 from other HNBs belonging to wireless network 100. A common reserved IMSI or IMEI value may be assigned by or otherwise belong to the operator of wireless network 100 and may differ from the IMSI or IMEI values assigned to any UE such as UE 104. In some embodiments, the HNB identification value may identify HNB 102 as being an HNB but may not provide a unique identification for HNB 102. If an HNB identification value is included, the SAS may store any location computed for the HNB in association with an HNB identification (e.g. the HNB serving cell ID that may be provided to SAS 110 in the PCAP Position Calculation Request message in message flow 200B or in the PCAP Information Exchange Initiation Request message in message flow 200A). The stored location of HNB 102 may be used later by SAS 110 in helping locate a UE (e.g. using E-CID or A-GNSS positioning) that may be nearby to or accessing the HNB 102.

In an embodiment, the HNB positioning shown in FIG. 2A and FIG. 2B can align with RNC centric positioning of a UE, as defined in 3GPP TS 25.305, in that the HNB 102 can support the same PCAP interactions with the SAS 110 that are used to support UE positioning in RNC centric mode.

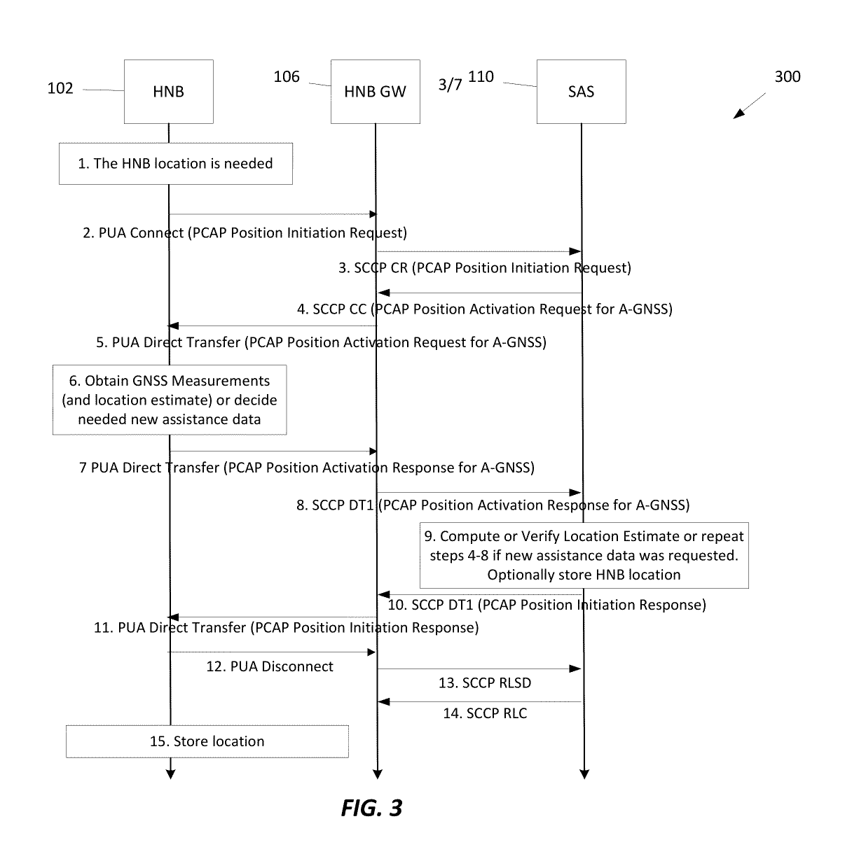

FIG. 3 shows a design of a message flow 300 for supporting location services and A-GNSS for HNB 102 using SAS 110. HNB 102 may determine that the location of HNB 102 is needed (step 1)—e.g. while HNB is being initialized or some time later. HNB 102 may send a PCAP Position Initiation Request message in a PCAP User Adaptation (PUA) Connect message to HNB GW 106 to initiate a location session with SAS 110 (step 2). The PUA Connect message may also contain the identity of a SAS (e.g., SAS 110). The PCAP Position Initiation Request message may include an RNC ID for the HNB GW 106 and/or the cell ID of the HNB 102. In an embodiment, the message may include the positioning capabilities of the HNB 102 (e.g., A-GNSS), etc. In a further embodiment, the message may include an HNB identification value. The HNB identification value may be a Client type parameter containing a value indicating that positioning is being requested for an HNB rather than for a UE. The HNB identification value may alternatively be a reserved IMSI or IMEI value indicating an HNB. With this embodiment, an RNC ID may not be included in the message. HNB GW 106 may forward the PCAP Position Initiation Request message in a SCCP Connection Request (CR) message to SAS 110 (step 3). HNB GW 106 may determine the SAS 110 from the identity of any SAS included in the PUA Connect message sent in step 2 or in other ways (e.g., by default if only one SAS is connected to HNB GW 106). SAS 110 may receive the PCAP Position Initiation Request message and may recognize that the request is from an HNB from inclusion of the RNC ID identifying the HNB GW. The SAS 110 may also or instead recognize the request is from an HNB because the PCAP Position Initiation Request includes a HNB identification value such as a Client Type parameter or a reserved IMSI or IMEI value. In an embodiment, the HNB identification value (e.g. a Client Type parameter or a reserved IMSI or IMEI value) or the RNC ID may indicate to SAS 110 that the PCAP Position Initiation Request was sent by an HNB in order to position the HNB rather than to position a UE (e.g. UE 104) that is accessing an HNB. In a further embodiment, the HNB identification value may uniquely identify HNB 102 (e.g. may distinguish HNB 102 from any other HNB for wireless network 100). In this case, the HNB identification value may comprise an IMSI or IMEI value (e.g. configured in HNB 102 at manufacture or during initialization) that is unique to HNB 102. Alternatively, the HNB identification value may only identify HNB 102 as being an HNB. In this case, the HNB identification value may be a common reserved IMSI or IMEI value that is configured in some or all HNBs for wireless network 100 or may be a Client Type parameter set to a value indicating an HNB.

The SAS 110 may initiate an A-GNSS positioning procedure by sending a PCAP Position Activation Request message, which may include assistance data for A-GNSS, in a SCCP Connection Confirm (CC) message sent to HNB GW 106 (step 4). HNB GW 106 may forward the PCAP Position Activation Request message in a PUA Direct Transfer message to HNB 102 (step 5). The SAS may initiate the A-GNSS positioning procedure in step 4 in response to an indication of support for A-GNSS positioning by HNB 102 included in the PCAP Position Initiation Request message transferred in steps 2 and 3 and/or in response to an indication in the HNB Identification value that positioning of an HNB and a not a UE is requested.

HNB 102 may receive the PCAP Position Activation Request message and may obtain GNSS measurements, e.g., based on the assistance data received from SAS 110 (step 6). HNB 102 may or may not be able to determine a location estimate based on the GNSS measurements and assistance data received in step 5. HNB 102 may send a PCAP Position Activation Response message, which may include the GNSS measurements and/or location estimate, in a PUA Direct Transfer message sent to HNB GW 106 (step 7). HNB GW 106 may forward the PCAP Position Activation Response message in a SCCP Data form 1 (DT1) message to SAS 110 (step 8).

SAS 110 may receive the GNSS measurements and/or location estimate from the PCAP Position Activation Response message in step 8. SAS 110 may compute a location estimate for the HNB 102 based on the GNSS measurements (if provided) and/or may verify or partly verify the location estimate for the HNB 102—e.g. using a known coverage area for HNB GW 106 or a previously stored location estimate for HNB 102 (step 9). SAS 110 may then send the location estimate computed and/or verified by SAS 110 in a PCAP Position Initiation Response message, which may be carried in a SCCP DT1 message sent to HNB GW 106 (step 10). HNB GW 106 may forward the PCAP Position Initiation Response message in a PUA Direct Transfer message to HNB 102 (step 11).

HNB 102 may terminate the location session with SAS 110 by sending a PUA Disconnect message to HNB GW 106 (step 12), which may send a SCCP Released message to SAS 110 (step 13). SAS 110 may return a SCCP Release Complete (RLC) message (step 14). HNB 102 may store its location estimate and/or provide the location estimate to another network resource, or to a UE 104.

In FIG. 3, SAS 110 may send assistance data for A-GNSS to HNB 102 in steps 4 and 5. HNB 102 may determine that it needs new assistance data in step 6—e.g. if the assistance data received in step 5 is insufficient to enable a sufficient number of accurate GNSS measurements to be obtained or to enable HNB 102 to compute a location estimate from these measurements. In this case, HNB 102 may send a request for assistance data to SAS 110 in steps 7 and 8 instead of sending GNSS measurements to SAS 110. Steps 4 to 8 may then be repeated by SAS 110 to provide new assistance data to HNB 102. Similarly in FIG. 3, SAS 110 may determine that it needs more measurements or another location estimate in step 9 and may repeat steps 4 to 8 in order to obtain the measurements or a location estimate from HNB 102.

While FIG. 3 shows use of A-GNSS, SAS 110 may invoke one or more additional or alternative positioning methods in steps 4 to 8. For example, SAS 110 may invoke Observed Time Difference of Arrival (OTDOA) and may include assistance data for OTDOA in the PCAP Position Activation message sent in steps 4 and 5. HNB 102 may then obtain OTDOA measurements or a location estimate based on OTDOA measurements in step 6 and may return the OTDOA measurements or location estimate to SAS 110 in a PCAP Position Activation Response message in steps 7 and 8. As another example, SAS 110 may invoke E-CID in the PCAP Position Activation message sent in steps 4 and 5 and HNB 102 may obtain E-CID measurements in step 6 and return these to SAS 110 in steps 7 and 8.

In an implementation in which an HNB identification value may not be included in steps 2 and 3, SAS 110 may send a request for E-CID measurements in a PCAP Position Activation Request (e.g. in steps 4 and 5 of FIG. 3) and HNB 102 may return a PCAP Position Activation Failure and an appropriate cause (e.g. “not supported”) if HNB 102 is unable to obtain the measurements. For this implementation, SAS 110 may not know that the positioning instigated by HNB 102 (e.g. in steps 2 and 3 in FIG. 3) is for HNB 102 rather than for a UE (e.g. UE 104). For example, even if HNB 102 includes an RNC ID for HNB GW 106 in steps 2 and 3 in FIG. 3, SAS 110 may only know that positioning is being requested by an HNB but not that positioning is being performed for an HNB rather than for a UE. Hence, SAS 110 may request E-CID measurements from HNB 102 which may be valid for positioning of a UE. However, for positioning of HNB 102, E-CID measurements may not be obtainable by HNB 102 and may not be applicable since they may assume measurement of signals from a UE by a base station (e.g. WCDMA node B). Hence, HNB 102 may need to respond to the request for E-CID measurements by SAS 110 with a failure indication as described above. In an embodiment, the PCAP Position Initiation Request message sent by the HNB 102 (e.g. at step 2 in FIG. 3) can indicate positioning of an HNB (e.g., by including an HNB identification value that may comprise a special value in the Client Type parameter or an IMSI or IMEI value set to some reserved value). SAS 110 may then recognize that positioning is for an HNB and may be configured to not send a request that cannot be supported by an HNB (e.g. the SAS 110 will not send a request for E-CID measurements that cannot be obtained by an HNB). In addition, after SAS 110 computes or verifies a location estimate for HNB 102 (e.g. at step 9 in FIG. 3), SAS 110 may store the location estimate in association with any provided identity for HNB 102 such as the serving cell identity for HNB 102 which may be included by HNB 102 in the PCAP Position Initiation Request message sent in steps 2 and 3. SAS 110 may subsequently use the stored location estimate for HNB 102 to help locate a UE (e.g. UE 104) that may be nearby to the HNB 102 or accessing the HNB 102. For example, SAS 110 may use the stored location to determine precise A-GNSS satellite acquisition assistance data for the UE, to assist in positioning the UE using E-CID measurements or as an approximate location estimate for the UE without further positioning of the UE.

In an embodiment, the HNB positioning shown in FIG. 3 can align with SAS centric positioning of a UE in that the HNB 102 can support the same PCAP interactions with the SAS 110 that are used to support UE positioning in SAS centric mode—e.g. as defined in 3GPP TS 25.305. The HNB 102 may invoke SAS centric positioning of HNB 102 in step 2 in FIG. 3 and may provide its positioning capabilities (e.g. capability to support A-GNSS including whether UE assisted and/or UE based and for which GNSS systems and GNSS signals), current serving cell ID (e.g. the assigned HNB cell ID) and required Quality of Service to the SAS. The SAS 110 can then invoke positioning by returning a PCAP position activation request to the HNB 102 in step 4. If A-GNSS positioning is invoked, the SAS 110 may include A-GNSS assistance data in this response compatible with the A-GNSS positioning capability of the HNB 102. In an example, an E-CID method could be invoked by the SAS 110 in step 4 with a request for few or no measurements in order to provide the SAS 110 with an initial approximate location of the HNB (e.g., to enable the SAS 110 to compute A-GNSS acquisition assistance data). A request for few or no E-CID measurements may be allowed in PCAP and can be based on the SAS 110 knowing that positioning is for the HNB 102—e.g. via inclusion of an HNB identification value in the PCAP Position Initiation Request sent in steps 2 and 3 in FIG. 3. In an example, the HNB 102 may include an initial approximate location for HNB 102 in the response to an E-CID positioning request from SAS 110 sent by HNB in step 7 in FIG. 3. The E-CID measurements or approximate HNB location received by SAS 110 at step 8 may then be used by SAS 110 to determine suitable A-GNSS assistance data for HNB 102 (e.g. suitable A-GNSS acquisition assistance data) and enable the SAS 110 to invoke A-GNSS positioning for HNB 102 by repeating steps 4 to 8, as described above, in FIG. 3

In an embodiment, the HNB identification value referred to above in association with the description of FIGS. 2A, 2B and 3 may be an IMSI or an IMEI that is set to a reserved value for a particular network that indicates an HNB. By using the same reserved value for the HNB Identification value for all HNBs (e.g. all HNBs in wireless network 100), network configuration may be simplified. For example, the reserved value may be hardcoded in each HNB at manufacture or may be configured by Operations and Maintenance in each HNB (e.g. during initialization of each HNB) or may be configured in other ways (e.g. by an HNB GW 106). The reserved value may be similarly configured or hardcoded in SAS 110. The reserved value may be a value that is not assigned to normal mobile stations (e.g. UE 104) and/or may be a value that is valid according to the standard definition of an IMSI or IMEI (e.g. may contain between 6 and 15 decimal digits in the case of an IMSI or 15 hexadecimal digits in the case of an IMEI). The reserved value may instead be an invalid value according to the normal definition of an IMSI or IMEI—e.g. a value containing fewer than 6 decimal digits, more than 15 decimal digits or hexadecimal digits in range 10 to 15 in the case of an IMSI or a value containing less than or more than 15 hexadecimal digits in the case of an IMEI. A reserved value that contains an invalid value may be recognized by SAS 110 as indicating an HNB due to being invalid or due to being a specific type of invalid value (e.g. an invalid value that contains a certain number of or certain values for decimal or hexadecimal digits). In some embodiments, the reserved value may not be precisely defined but may just conform to some rule—e.g. may contain a string of hexadecimal digits in the range 10 to 15 in the case of an IMSI.

It should be noted that while positioning of an HNB is exemplified by the methods associated with FIGS. 2A, 2B and 3, the same methods may be applied to positioning of an HNB GW (e.g. HNB GW 106), an RNC or any other network element that can interact with an SAS using PCAP messages. The network element that is positioned (e.g. RNC or HNB GW) would then replace HNB 102 in FIGS. 2A, 2B and 3 but could perform the same functions as described for HNB 102 for FIGS. 2A, 2B AND 3.

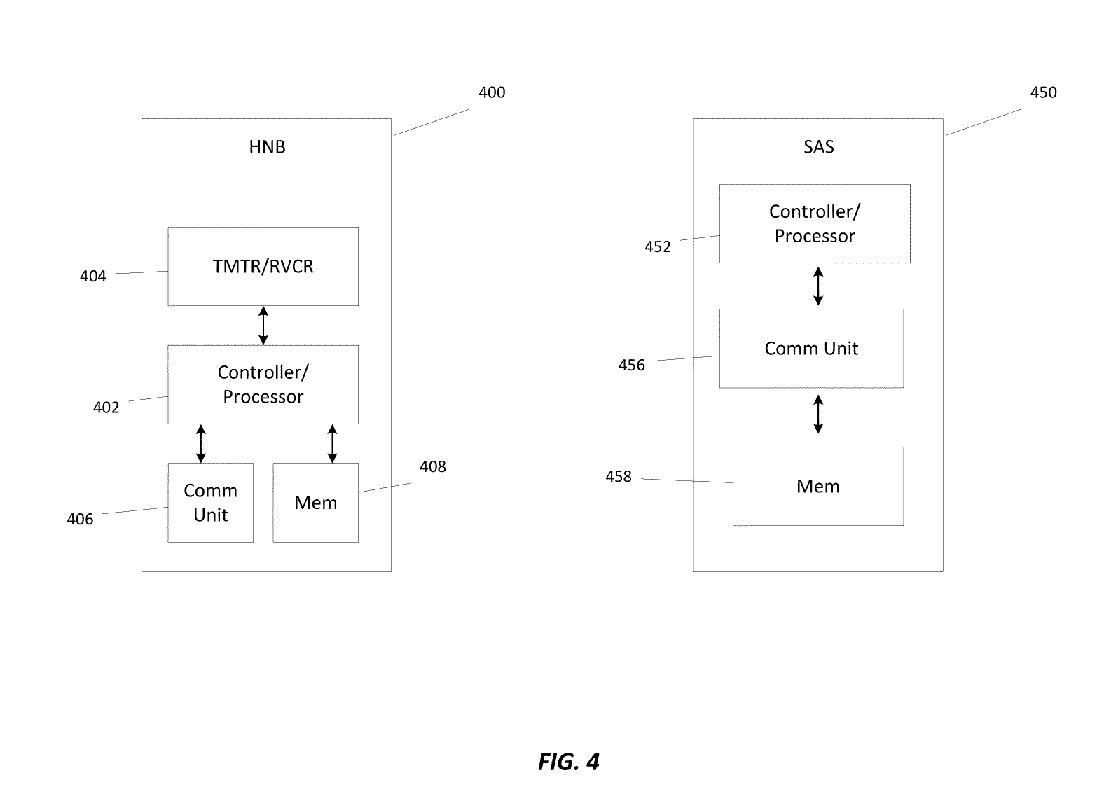

FIG. 4 shows a block diagram of a design of an HNB 400 and a SAS 450. The HNB 400 may be HNB 102 and the SAS 450 may be SAS 110 in FIGS. 1, 2A, 2B and 3. For simplicity, FIG. 4 shows one controller/processor 402, one transmitter/receiver unit (TMTR/RCVR) 404 (e.g. which may include an antenna unit), one communication (Comm) unit 406 and one memory unit (Mem) 408 for the HNB 400, and a controller/processor 452, a communication unit 456, and one memory (Mem) 458 for the SAS 450. In general, the HNB 400 and SAS 450 may include any number of controllers, processors, memories, transceivers, and communication units.

The HNB 400 may transmit and receive traffic data, signaling, broadcast information, and/or pilot to UEs within its coverage. These various types of data may be processed by processor 402, conditioned by transmitter/receiver 404, and transmitted via a downlink. The memory 408 may store program codes and data for the HNB 400. The processor 402 may also perform processing for HNB 102 in the message flows in FIGS. 2A, 2B and 3. HNB 400 may communicate with other network entities via the Comm unit 406 such as HNB GW 106.

Within the SAS 450, the controller/processor 452 may perform processing to support location services and positioning, memory 458 may store program codes and data for procession processing and communication, and the communication unit 456 may allow the SAS 450 to communicate with other entities such as HNB GW 106 and UE 104. The controller/processor 452 may perform processing of messages streams such as described in FIGS. 2A, 2B, 3, and 7, and/or processes for supporting location services as described herein.

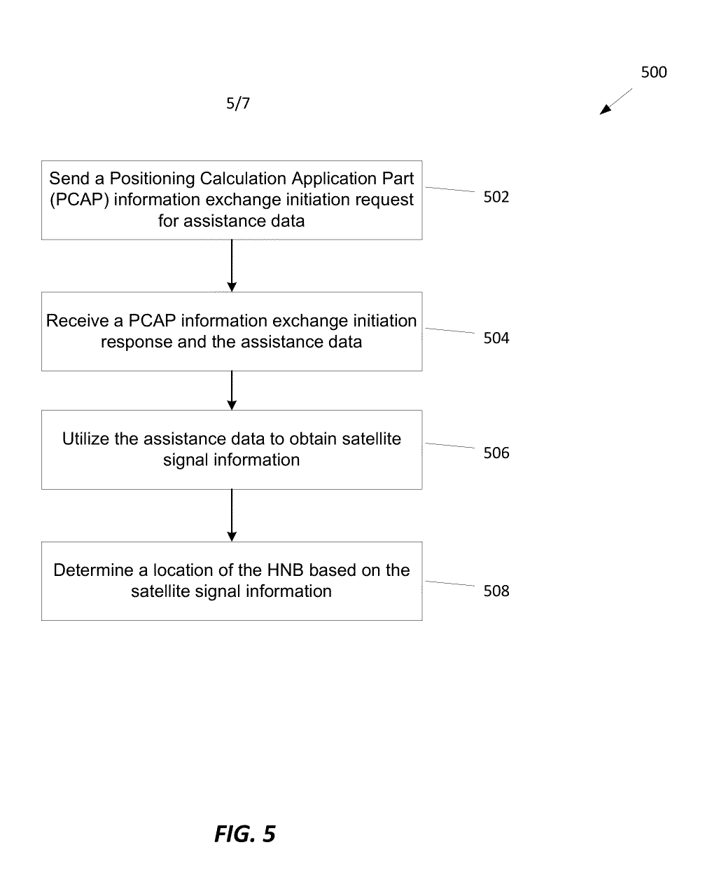

FIG. 5 shows a process 500 of supporting location services for an HNB 400 or an HNB 102 and includes the stages shown. The process 500 is, however, an example only and not limiting. The process 500 can be altered, e.g., by having stages added, removed, rearranged, combined, performed concurrently and/or having stages split into multiple stages. In an embodiment, the HNB 400 may include processor executable instructions corresponding to the process 500 stored in the memory 408, and the controller/processor 402 can be configured to execute the instructions.

At stage 502, the HNB 400 may be configured to send a PCAP information exchange initiation request for assistance data to the SAS 110. The PCAP information exchange initiation request may conform with industry standards such as 3GPP TS 25.453, and may or may not include an HNB identification value. The HNB identification value, if included, may indicate that the PCAP information exchange initiation request was sent by an HNB (e.g., and not sent by an RNC), may also or instead indicate the positioning is for an HNB (e.g. and is not for a UE) and/or may uniquely identify the HNB 400 (e.g. may identify and distinguish HNB 400 from any other HNBs belonging to the wireless operator such as other HNBs in the wireless network 100). Other classification values may be used. The Comm unit 406 may be a means for sending a PCAP information exchange initiation request based on the instructions executing in the controller/processor 402.

At stage 504, the HNB 400 may be configured to receive a PCAP information exchange initiation response and the assistance data. The assistance data can be A-GNSS information to enable the HNB to more effectively acquire and measure GNSS satellites and possibly determine its position based on GNSS measurements. At stage 506, the HNB 400 may utilize the assistance data to obtain the GNSS satellite signal information. If there are errors or other problems in obtaining the GNSS satellite signal information, the HNB 400 may be configured to send a request for additional assistance data. The Comm unit 406 may be a means for receiving a PCAP information exchange initiation response, and may be a means for receiving the additional assistance data, based on the instructions executing in the controller/processor 402.

At stage 508, the controller/processor 402 in the HNB 400 may be configured to determine is location based on the satellite signal information obtained at stage 506 and the assistance data received at stage 504. The location of the HNB 400 can be stored locally (e.g., in memory 408), and/or may be sent to the SAS 110 or to one or more UEs. The HNB 400 location information may also be sent to other network entities (e.g. to an HNB Management System).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

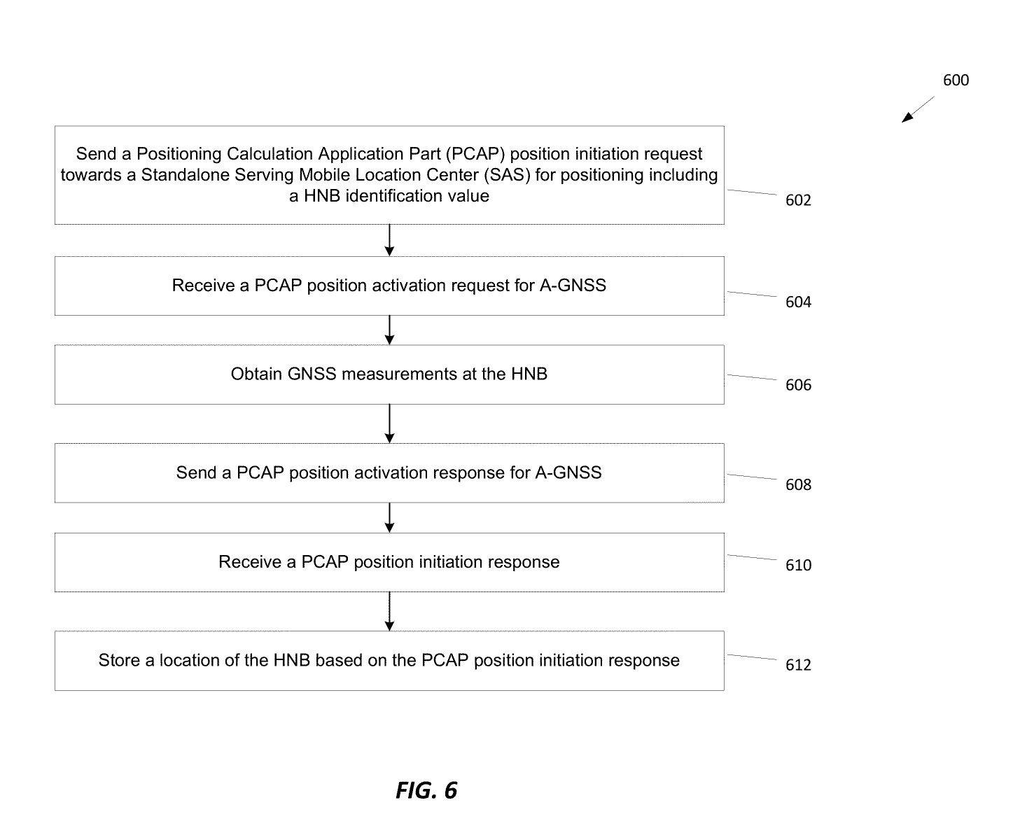

FIG. 6 shows a process 600 for determining and storing a location of an HNB 400 or an HNB 102 and includes the stages shown. The process 600 is, however, an example only and not limiting. The process 600 can be altered, e.g., by having stages added, removed, rearranged, combined, performed concurrently and/or having stages split into multiple stages. In an embodiment, the HNB 400 may include processor executable instructions corresponding to the process 600 stored in the memory 408, and the controller/processor 402 can be configured to execute the instructions.

At stage 602, the processor 402 may be configured to provide instructions to the communications unit 406 to send a PCAP position initiation request towards an SAS 110 for position including a HNB identification value. The HNB identification value may be stored in memory 408, and (i) may cause the SAS to identify the sender of the message as being an HNB (e.g. and not an RNC), (ii) may cause the SAS to determine that positioning is being requested for an HNB (e.g. and not for a UE) and/or (iii) may uniquely identify the particular HNB (e.g., using a serial number, device identity, IP address, MAC address, SSID, serving cell identity, IMSI or IMEI). In operation, the SAS 110 can be configured to recognize the request is from an HNB and/or to recognize that the request is for positioning of an HNB based on the HNB identification value. In an embodiment, the PCAP position initiation request can flow through a HNB GW 106 before reaching the SAS 110.

At stage 604, the HNB 400 may receive a PCAP position activation request for A-GNSS. The PCAP position activation request may be sent from the SAS 110 and may flow through the HNB GW 106. The PCAP position activation request for A-GNSS may include assistance data to be stored in the memory 408 and used to help acquire and measure satellite signals and/or to help compute a location from the satellite measurements. For example, at stage 606 the HNB may be configured to obtain GNSS measurements from one or more satellites. For example, the transmitter/receiver 404 may include means for obtaining GNSS measurements. Other GNSS receivers may also be used. The assistance data can be used to select one or more satellites to be used in position calculations. At stage 606, the HNB may also compute a location estimate based on the obtained GNSS measurements and the assistance data received at stage 604. At stage 608, the HNB 400 may be configured to send a PCAP activation response for A-GNSS. The response may include the GNSS measurements and/or a location estimate. The SAS 110 may be configured to process the PCAP position activation response to determine a location of the HNB. The SAS may be configured to store the location of the HNB—e.g. in association with an identification of the HNB such as a cell ID.

At stage 610, the HNB 400 may be configured to receive a PCAP position initiation response from the SAS 110 (or the HNB GW 106). The PCAP position initiation response may include the position of the HNB 400 as determined or verified by the SAS 110 based on the GNSS measurements or location estimate included in the PCAP position activation response provided by the HNB 400 at stage 608. At stage 612, the HNB can store the location of the HNB based on the PCAP position initiation response. For example, the location may be stored in memory 408. In an embodiment, the location of the HNB 400 can be sent to one or more UEs, or may be stored on a remote almanac (e.g., a position server).

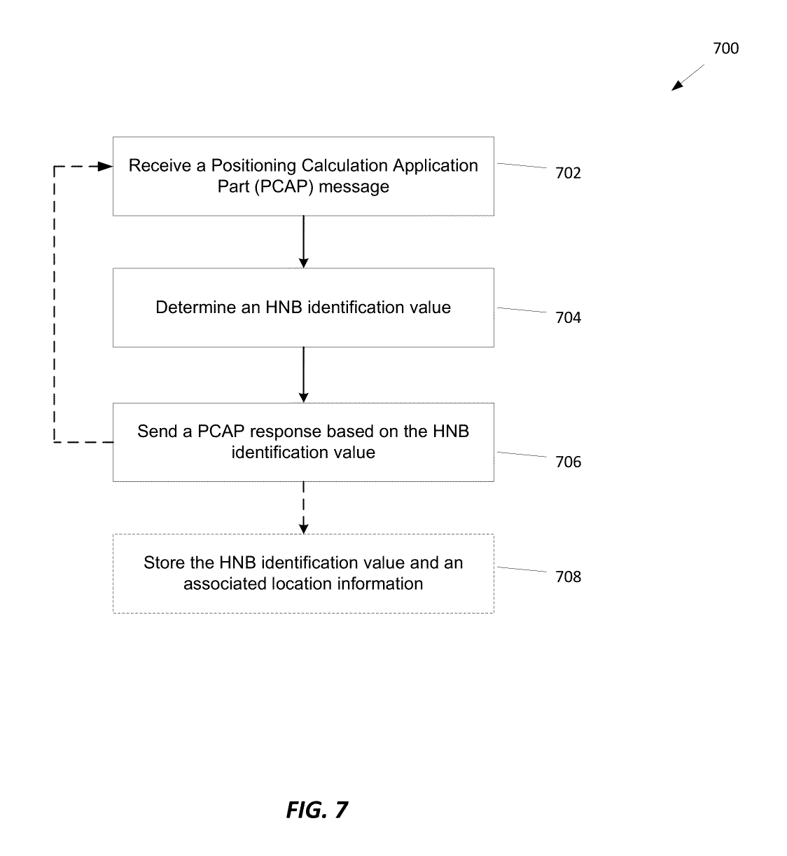

FIG. 7 a process 700 for determining a HNB identification from a PCAP information exchange request includes the stages shown. The process 700 is, however, an example only and not limiting. The process 700 can be altered, e.g., by having stages added, removed, rearranged, combined, performed concurrently and/or having stages split into multiple stages. In an embodiment, the SAS 450 may include processor executable instructions corresponding to the process 700 stored in the memory 458, and the controller/processor 452 can be configured to execute the instructions.

At stage 702, an SAS 450 may be configured to receive a PCAP message from an HNB 102 or an HNB GW 106. The SAS 450 includes a controller/processor 452, and memory 458 and may be configured to execute computer readable instructions such as for decoding data streams. The received PCAP message may be, for example, a PCAP information exchange initiation request, a PCAP position calculation request or a PCAP position initiation request sent from an HNB 102 or an HNB 400. The PCAP message may include an HNB identification value. At stage 704, the SAS 450 may be configured to determine the HNB identification value based on the received message. The SAS 450 may utilize the HNB identification value to identify the sender of the message as being an HNB. In an embodiment, the SAS 450 may uniquely identify a particular HNB based on the HNB identification value (e.g., using a serial number, device identity, IP address, MAC address, SSID, serving cell identity, IMSI or IMEI). In a further embodiment, the SAS 450 may determine based on the HNB identification value that the received PCAP message was sent to support positioning of an HNB rather than positioning of a UE.

At stage 706, the SAS 450 may send a PCAP response based on the received PCAP message. The PCAP response may be a PCAP information exchange initiation response, a PCAP position calculation response, a PCAP position activation request, a PCAP Position Initiation Response or some other response. In an embodiment, the HNB identification value may comprise a special value in a Client Type parameter in the received PCAP message at stage 702 or may comprise a reserved IMSI or IMEI value or a common reserved IMSI or IMEI value. The SAS 450 may then recognize that positioning is for an HNB and may be configured to not send a request response that cannot be supported by an HNB (e.g. the SAS 450 may not send a request for certain E-CID measurements). In an embodiment as indicated by the dashed line in FIG. 7, stage 702 and stage 704 may be repeated one or more times—e.g. to allow SAS 450 to receive GNSS measurements or a request for assistance data from the HNB and to compute a location from the GNSS measurements or provide the requested assistance data to the HNB, respectively.

Stage 708 is indicated in dashed lines and is considered an optional step. The SAS 450 can be configured to store the location information—e.g. a location estimate for the HNB. For example, if stage 702 and stage 706 are repeated, SAS 450 may receive a PCAP position activation response for A-GNSS from the HNB during a repetition of stage 702 and the SAS 450 may be configured to then compute a location estimate for the HNB 102. The SAS 450 may subsequently store the location estimate locally (i.e., in local memory), or may provide the location estimate to another network resource (e.g., position server or other almanac) for use in future positioning calculations. The location estimate for the HNB may be stored and/or provided by SAS 450 in association with an identity for the HNB such as the cell ID served by the HNB or a unique IMSI or IMEI value for the HNB.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor and includes processor-readable instructions, such that the processor can read information from, and write information to, the storage medium (i.e., a processor-readable storage medium). In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored as one or more instructions or code on a computer-readable medium. Computer-readable media does not refer to transitory propagating signals (e.g., it may be non-transitory). A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of determining a location of a Home Node B (HNB), comprising:
sending a Positioning Calculation Application Part (PCAP) position initiation request towards a Standalone Serving Mobile Location Center (SAS) for positioning including a HNB identification value;
receiving a PCAP position activation request for Assisted Global Navigation Satellite System (A-GNSS);
obtaining GNSS measurements at the HNB;
sending a PCAP position activation response for A-GNSS;
receiving a PCAP position initiation response; and
storing the location of the HNB based on the PCAP position initiation response.

2. The method of claim 1, further comprising:
sending a request for additional assistance data towards the SAS; and
receiving the additional assistance data based on the request.

3. The method of claim 1, wherein the PCAP position activation request for A-GNSS and the PCAP position initiation response are received from a HNB Gateway (GW).

4. The method of claim 1, wherein the HNB identification value comprises a value for a Client Type parameter.

5. The method of claim 4, wherein the HNB identification value indicates the location of an HNB to the SAS.

6. The method of claim 5, wherein in response to an indication of the location of the HNB, the SAS stores the location of the HNB.

7. The method of claim 1, wherein the HNB identification value comprises a common reserved International Mobile Subscriber Identity (IMSI) or International Mobile Equipment Identity (IMEI) value.

8. The method of claim 1, wherein receiving the PCAP position activation request includes a request for Enhanced Cell ID (E-CID) measurements from the SAS, and the PCAP position activation response includes returning an approximate location for the HNB to the SAS.

9. An apparatus for determining a location of a Home Node B (HNB), comprising:
a memory unit for storing instructions; and
a processor and communications unit coupled to the memory unit and configured to:
send a Positioning Calculation Application Part (PCAP) position initiation request towards a Standalone Serving Mobile Location Center (SAS) for positioning including a HNB identification value;
receive a PCAP position activation request for Assisted Global Navigation Satellite System (A-GNSS);
obtain GNSS measurements at the HNB;
send a PCAP position activation response for A-GNSS;
receive a PCAP position initiation response; and
store the location of the HNB in the memory unit based on the PCAP position initiation response.

10. The apparatus of claim 9, wherein the processor and communication unit are further configured to:
send a request for additional assistance data towards the SAS; and
receive the additional assistance data based on the request.

11. The apparatus of claim 9, wherein the PCAP position activation request for A-GNSS and the PCAP position initiation response are received from a HNB Gateway (GW).

12. The apparatus of claim 9, wherein the HNB identification value comprises a value for a Client Type parameter.

13. The apparatus of claim 12, wherein the HNB identification value indicates the location of the HNB to the SAS.

14. The apparatus of claim 13, wherein in response to an indication of the location of the HNB, the SAS stores the location of the HNB.

15. The apparatus of claim 9, wherein the HNB identification value comprises a common reserved International Mobile Subscriber Identity (IMSI) or International Mobile Equipment Identity (IMEI) value.

16. The apparatus of claim 9, wherein receiving the PCAP position activation request includes a request for Enhanced Cell ID (E-CID) measurements from the SAS, and the PCAP position activation response includes returning an approximate location for the HNB to the SAS.

17. A non-transitory processor-readable storage medium comprising instructions for determining a location of a Home Node B (HNB), the instructions comprising:
code for sending a Positioning Calculation Application Part (PCAP) position initiation request towards a Standalone Serving Mobile Location Center (SAS) for positioning including a HNB identification value;
code for receiving a PCAP position activation request for Assisted Global Navigation Satellite System (A-GNSS);
code for obtaining GNSS measurements at the HNB;
code for sending a PCAP position activation response for A-GNSS;
code for receiving a PCAP position initiation response; and
code for storing the location of the HNB based on the PCAP position initiation response.

18. The non-transitory processor-readable storage medium of claim 17, further comprising:
code for sending a request for additional assistance data towards the SAS; and
code for receiving the additional assistance data based on the request.

19. The non-transitory processor-readable storage medium of claim 17, wherein the PCAP position activation request for A-GNSS and the PCAP position initiation response are received from a HNB Gateway (GW).

20. The non-transitory processor-readable storage medium of claim 17, wherein the HNB identification value comprises a value for a Client Type parameter.

21. The non-transitory processor-readable storage medium of claim 20, wherein the HNB identification value indicates the location of the HNB to the SAS.

22. The non-transitory processor-readable storage medium of claim 17, wherein the code for receiving the PCAP position activation request includes code for receiving a request for Enhanced Cell ID (E-CID) measurements from the SAS, and code for returning an approximate location for the HNB to the SAS via the PCAP position activation response.

23. An apparatus for determining a location of a Home Node B (HNB), comprising:
means for sending a Positioning Calculation Application Part (PCAP) position initiation request towards a Standalone Serving Mobile Location Center (SAS) for positioning including a HNB identification value;
means for receiving a PCAP position activation request for Assisted Global Navigation Satellite System (A-GNSS);
means for obtaining GNSS measurements with the HNB;
means for sending a PCAP position activation response for A-GNSS;
means for receiving a PCAP position initiation response; and
means for storing the location of the HNB based on the PCAP position initiation response.

24. The apparatus of claim 23, further comprising:
means for sending a request for additional assistance data towards the SAS; and
means for receiving the additional assistance data based on the request.

25. The apparatus of claim 23, wherein the PCAP position activation request for A-GNSS and the PCAP position initiation response are received from a HNB Gateway (GW).

26. The apparatus of claim 23, wherein the HNB identification value comprises a value for a Client Type parameter.

27. The apparatus of claim 26, wherein the HNB identification value indicates the location of the HNB to the SAS.

28. The apparatus of claim 27, wherein in response to an indication of the location of the HNB, the SAS stores the location of the HNB.

29. The apparatus of claim 23, wherein the HNB identification value comprises a common reserved International Mobile Subscriber Identity (IMSI) or International Mobile Equipment Identity (IMEI) value.

30. The apparatus of claim 23, further comprising:
means for receiving the PCAP position activation request including a request for Enhanced Cell ID (E-CID) measurements from the SAS; and
means for returning the PCAP position activation response including an approximate location for the HNB to the SAS.
